(19) United States
(12) Patent Application Publication
(10) Pub. No.: US 2006/0206441 A1
(43) Pub. Date: Sep. 14, 2006

(54) Method of marketing real estate having observable activity enclosure

(76) Inventor: Robert W. McKey, Atlanta, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/448,418

(22) Filed: Jun. 7, 2006

(51) Int. Cl. G06F 17/00

(52) U.S. Cl. 705/500

(57) ABSTRACT

A method of marketing real estate, wherein homes are sold to home purchasers who have, or plan to have, children. The homes are in a subdivision that has a commonly usable activity area for children and the activity area has a central location for supervising adults to observe their children while the adults are sitting, cooking, eating and/or communicating with other adults and/or children. Each family is provided with sets of activity equipment that is marked for the home purchasing owner for use on the activity area. The activity area comprises a central location with benches/tables and charcoal grills, and has game segments radiating outward from the central location.

### TECHNICAL FIELD

The present invention relates generally to methods of marketing, and more specifically to a method of marketing real estate, wherein the real estate is marketed in conjunction with an observable activity enclosure.

### BACKGROUND OF THE INVENTION

Many developers and/or home builders create subdivisions that include some common land and amenities in order to make the subdivisions more attractive to home purchasers. Typically, such amenities include a clubhouse, tennis courts and/or a swimming pool. Unfortunately, such amenities require significant capital that must be recovered through the purchase price of the house therein and further require upkeep costs that are borne by the home purchasers typically through their homeowners' association.

Unfortunately, many couples in their early years have not yet reached the higher ranges of their earnings, and, thus, are unable or unwilling to spend their discretionary income on high maintenance activity facilities like tennis courts and swimming pools. Further, their children are typically at a younger age wherein the ability of the children to utilize such facilities is minimal, at best.

Accordingly, since young couples have limited funds, they are not attracted by marketing efforts advertising such higher cost amenities, even more so because the amenities result in higher priced homes. However, such new home purchasers do desire play areas for their children. In particular, they desire secure play areas in which they can monitor their children's activities, and in which they can socialize with other adults and/or partake of family-oriented activities.

Moreover, children cause a significant lifestyle change to their parents, including increased costs that impact the family budget and a greater need for parents to remain nearby, in an observant position, to provide supervision and secure protection to the children. Further, adults who are confined within the home with their children are likely to go ‘stir crazy’ and/or have ‘cabin fever’, wherein relationships are strained, and wherein social skills remain undeveloped and without opportunity for growth. Thus, it is desirable for the adults to be able to communicate with, and socialize with, other adults, and for the children to play with other children. Accordingly, it is desirable for any subdivision of homes that will attract adults with small children to have facilities for congregation of adults in order to communicate with one another, while at the same time affording an observation point for parents to keep a close eye on, and protect, their children.

When parents are supervising and observing their children at play, it is desirable that the parents have the opportunity for other activities of their own and/or in concert with their children. Such other activities often include conducting a family meal, wherein the children can play, under close observation, while the parents prepare a meal. Subsequently, when the meal is ready, the children are in close proximity and can quickly join their parents in partaking of food and enjoying family interactions.

Previous methods of marketing real estate have relied on the inclusion of the aforementioned tennis courts and swimming pools to attract new home buyers. Traditional swing sets and slides are sometimes included in subdivisions to provide minimal recreation for small children. However, such play areas lack the variety needed to attract home purchasers who need to keep their children entertained, or are disbursed through the subdivision and thus lack a central location from which parents can observe their children while socializing and/or preparing food. Further, such disbursed play areas require that children move through the subdivision from one play area location to another, causing the children to undertake risks, and causing the children to no longer be in the proximity of their home from which they can be observed.

Therefore, it is readily apparent that there is a need for a method of marketing real estate that provides a secure activity enclosure for children, with a variety of play areas, wherein new home purchaser are attracted by the fact that their children are readily observed while at play, and wherein the adults can socialize with one another and conduct other activities, such as food preparation and eating while observing their children.

### BRIEF SUMMARY OF THE INVENTION

Briefly described, in a preferred embodiment, the present invention overcomes the above-mentioned disadvantages and meets the recognized need for such a method of marketing real estate having an observable activity enclosure by providing a method wherein a home is marketed to young adult homeowners who require a secure play area in which the adults can observe their children at play, while socializing with other adults and/or cooking, serving and eating food with their children. The homeowners are further provided with sets of implements for conducting the play activities that have identification indicia thereon to mark their ownership by a particular family.

The method of the present invention is particularly suited for marketing and advertising homes to new young home purchasers with children, or planning on having children. It is further suited for marketing/advertising homes in small subdivisions, where the subdivision is too small to economically support large activity areas such as clubhouses, swimming pools and/or tennis courts. Thus, subdivisions can be developed and marketed that would otherwise be economically unfeasible. Further, the lower costs of the activity enclosure of the present invention permit new homeowners, usually young adults with very young children, to live in a subdivision with secure activity areas for their children, while paying low homeowners' association fees.

According to its major aspects and broadly stated, the present invention in its preferred form is a method of marketing real estate having an observable activity enclosure, wherein the method comprises purchasing land, subdividing the land into home building lots and a commonly-usable secure activity enclosure. Within the secure activity enclosure, a central location, adapted for observing children playing with or without game equipment therein, comprises one or more game activity play areas that extend radially from the central location.

The method further includes constructing homes and the secure activity enclosure on the home building lots and offering the homes for sale to purchasing occupants via marketing information indicating that the purchasing occupants have access to, and use of, the activity enclosure. The secure activity enclosure may selectively be constructed on home lots or on any available space within the subdivision, or on a lot that is unsuitable for constructing homes, thereby permitting optimum efficient use of land space.

Marketing information may selectively be conveyed via the Internet, or via conventional posters, signage, multiple listing books, and the like. Additionally, the game equipment has indicia thereon with the name of at least one of said purchasing occupants to identify the purchasing occupants of the homes, and is provided to the purchasing occupants for use with the game activities.

Adult purchasing occupants may selectively perform activities in the central area, such as, for exemplary purposes only, cooking food, eating food, communicating with other purchasing occupants, and/or socializing with other purchasing occupants, all while observing their children at play in game activity areas within the activity enclosure that extend radially from the central area. By permitting the adults to conduct their activities from a central location while being able to easily view their children at play, the safety of the children is ensured.

More specifically, the present invention is a method of marketing real estate having an observable activity enclosure, wherein the method comprises purchasing land, subdividing the land into lots and a secure activity enclosure. Subsequently, homes are preferably built on lots, and the secure activity enclosure is preferably constructed on a lot, or on land that would otherwise be unsuitable for home construction. Homes are advertised and sold, wherein the advertising could comprise advertising via the Internet. It will be recognized by those skilled in the art that homes could be advertised and sold prior to construction thereof and/or prior to construction of secure activity area. Homes purchasers are provided with activity equipment for use on play areas that comprise segments within the secure activity enclosure, wherein the activity equipment is labeled with the name of the owner thereof.

The activity enclosure has segments, a central observation area, a fence, a restricted access gate, light standards and segment division lines. The segments comprise activity areas with games, such as, for exemplary purposes only, croquet pitches, miniature golf courses, paddleball courts, golf pool, basketball courts, and play areas with Jungle Gyms and/or sand pits therein. There are large basketball goal courts for adults and teenagers, and small basketball goal courts for younger children, thereby permitting children and adults to play near one another. The various segments can be readily changed at low incremental costs, since the entire activity enclosure does not have to be changed. As such, selection of activities is readily accomplished for seasonal changes, or merely to provide a variety of entertainment or sporting venues.

The central observation area is covered by a canopy to protect against inclement weather, and has grills for cooking food, tables for eating, reading or the like, and benches. The grills are generally centrally located within the central observation area and the tables are generally disposed in a circular fashion around the grills. The benches are generally disposed circularly around the tables, wherein the adults/parents/home purchasers can sit on the benches to observe the play of children. Whilst observing their children, the adults can cook on grills, and/or socialize and communicate with other adults and children. The segments comprise games, wherein children play the games by utilizing game activity implements/equipment, and wherein the activity equipment has indicia thereon to identify the family of a selected home purchaser.

Adults and children desirous of performing various social activities enter the activity enclosure via a restricted access gate. A fence defines the activity enclosure and serves to prevent unauthorized access, wherein access is via the restricted access gate. Light standards permit activities to be carried out during dusk or darkness.

Adults provide labeled game equipment to the children for use on the activity areas and the children play therewithin, whilst the adults observe their children. The adults can further optionally cook, communicate with other adults or with children, and/or socialize with other adults or with children, such that families can eat, communicate and/or socialize together.

It will be recognized by those skilled in the art that the activity enclosure could be rectangular in shape with triangular segments surrounding and radiating out from the central observation area.

Thus, the present invention provides a method of marketing homes in a neighborhood that has a safe, secure play area for children, in which adults can observe their children playing, while the adults conduct other activities from a central location.

Accordingly, a feature and advantage of the present invention is its ability to provide marketing of homes with recreational activities within subdivisions to homebuyers who would not otherwise be able to afford such.

Another feature and advantage of the present invention is its ability to attract new home buyers with young children.

Still another feature and advantage of the present invention is its ability to market a housing subdivision having a secure environment for young children.

Yet another feature and advantage of the present invention is its ability to market the use of otherwise un-buildable land that provides benefits to prospective homebuyers.

Yet still another feature and advantage of the present invention is that it provides for marketing to new home purchasers the recreational variability and low association maintenance costs.

A further feature and advantage of the present invention is that it provides for marketing a subdivision having a forum for neighbors to communicate and socialize.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a flow chart of the method of marketing homes in a subdivision having an observable activity enclosure according to a preferred embodiment of the present invention, wherein parents observe their children;

FIG. 2 is a continuation flow chart of the method of marketing homes in a subdivision having an observable activity enclosure according to a preferred embodiment of the present invention, wherein parents observe their children;

FIG. 3 is a perspective view of a subdivision of homes having an observable activity enclosure, according to a preferred embodiment of the present invention; and

FIG. 4 is a perspective view of an observable activity enclosure component as provided to homeowners via the marketing method according to a preferred embodiment of the present invention.

### DETAILED DESCRIPTION OF THE PREFERRED AND SELECTED ALTERNATIVE EMBODIMENTS

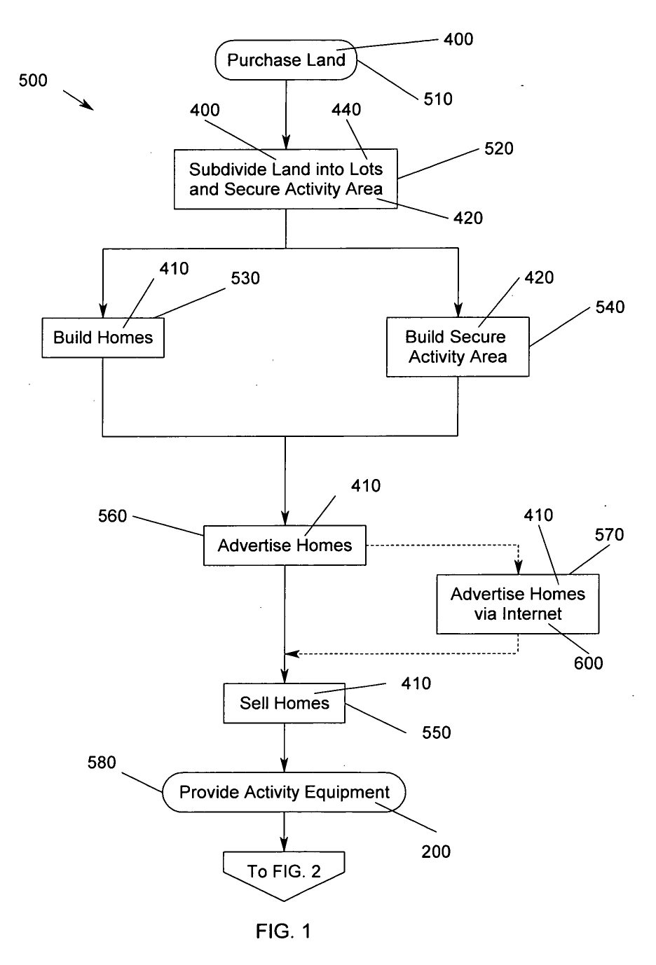

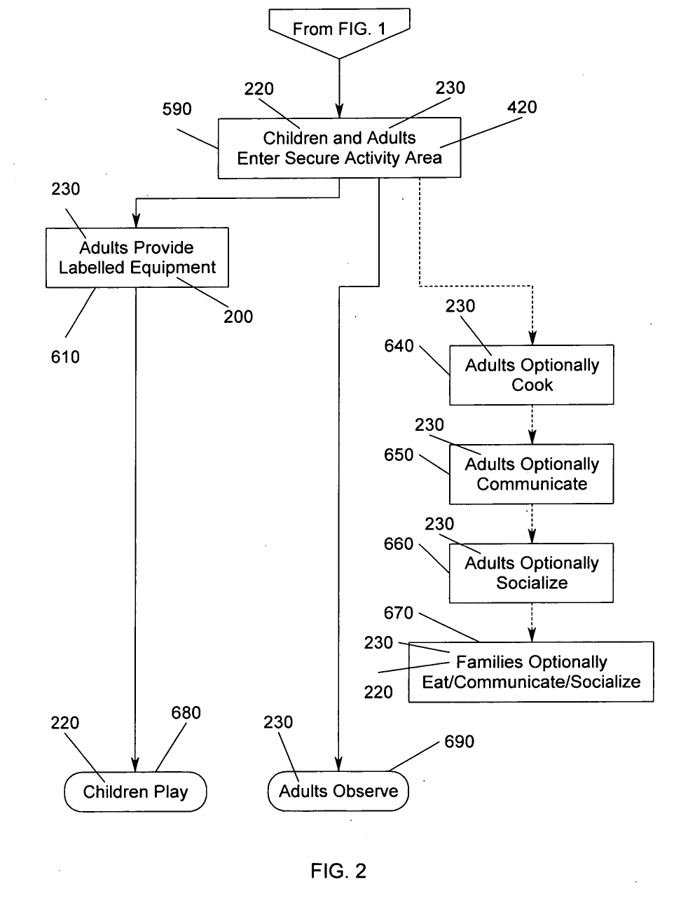

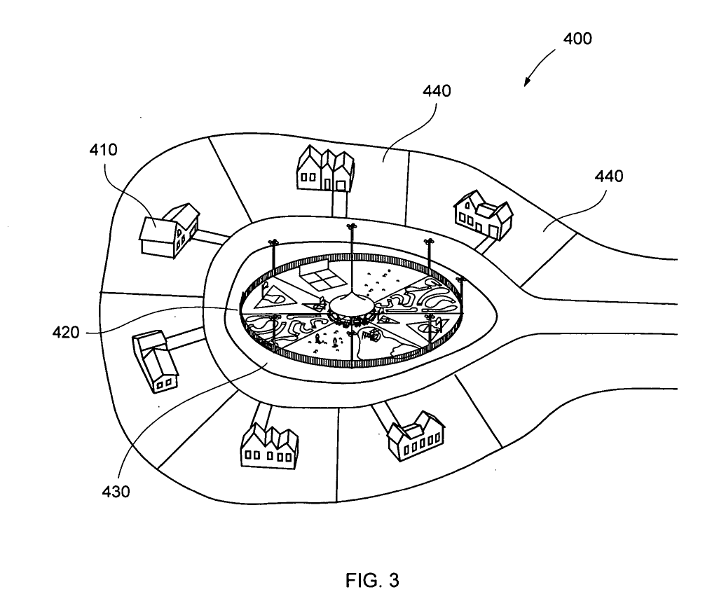

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-4, the present invention in a preferred embodiment is method of marketing real estate 100 having an observable activity enclosure 420, wherein method 100 preferably comprises step 510 of purchasing land 400. Subsequently, land 400 is preferably subdivided via step 520, preferably into lots 440 and secure activity area 420. Following step 520, homes 410 are preferably built via step 530 on lots 410 and secure activity area 420 is preferably constructed via step 540. Homes 410 are preferably advertised via step 560 and sold in step 550, wherein step 560 could comprise advertising via Internet 600 in step 570. It will be recognized by those skilled in the art that homes 410 could be advertised (step 560) and sold (step 550) prior to construction (step 540) of secure activity area 420, and/or prior to homes 410 being built (step 530). Purchasers of homes 410 are preferably provided with activity equipment 200 via step 580, wherein activity equipment 200 preferably comprises indicia 210 to indicate the owner thereof.

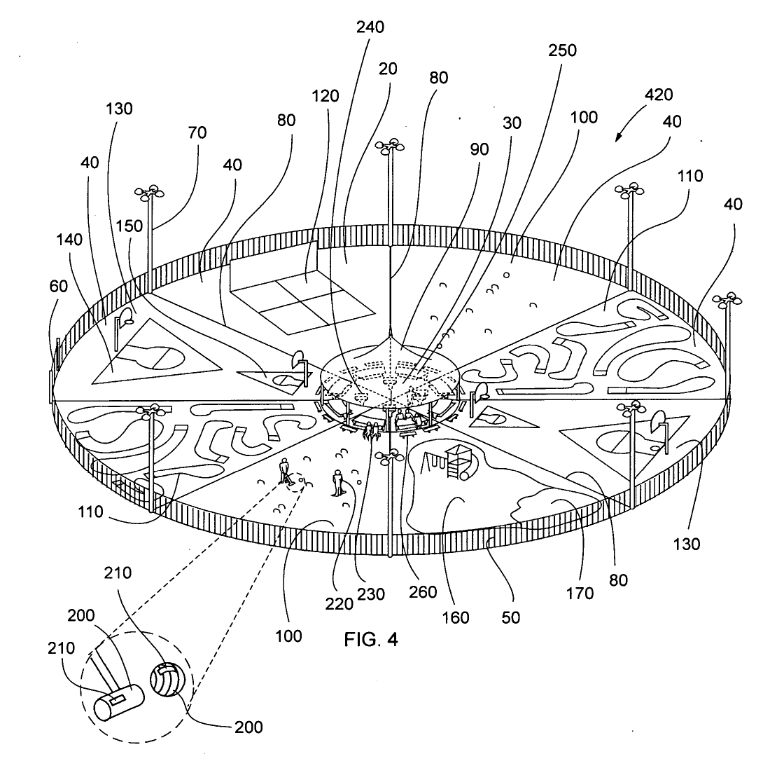

Referring now more particularly to FIG. 4, illustrated therein is the activity enclosure component of the present invention comprising segmented observable activity enclosure 420, preferably having segments 20, central observation area 30, fence 50, restricted access gate 60, light standards 70 and segment division lines 80. Segments 20 preferably comprise activity areas 40, wherein activity areas 40 preferably selectively comprise games, such as, for exemplary purposes only, croquet pitches 100, miniature golf courses 110, paddleball courts 120, basketball courts 130, and play area 160. Basketball courts 130 preferably comprise large basketball goal court 140 and small basketball goal court 150, wherein small basketball goal court 150 is preferably more suited to smaller children 220, thereby preferably permitting children 220 to play in close proximity to adults 230, and preferably facilitates instruction of children. Play area 160 preferably comprises sand pit 170, and could alternately comprise a Jungle Gym or other apparatus to entertain children 220.

Central observation area 30 preferably comprises canopy 90, grills 240, tables 250 and benches 260, wherein grills 240 are preferably generally centrally located within observation area 30, and wherein tables 250 are preferably disposed in a circular fashion around grills 240, and wherein benches 260 are preferably disposed circularly around tables 250. Adults/parents/home purchasers 230 can preferably selectively sit on benches 260 to observe the play of children 220, at tables 250, or can cook on grills 240, while observing children 220.

Segment 20 preferably comprises croquet pitch 100, wherein children 220 preferably play croquet by utilizing activity implements 200, and wherein activity implements 200 preferably comprise indicia 210. Indicia 210 preferably serve to identify the family of a selected home purchaser 230.

Adults 230 and children 220 desirous of performing various social activities preferably enter segmented observable activity enclosure 420 via restricted access gate 60. Fence 50 preferably defines segmented observable activity enclosure 420 and serves to prevent unauthorized access, wherein access is preferably only via restricted access gate 60.

Light standards 70 preferably permit activities to be carried out during dusk or darkness, and canopy 90 preferably provides shelter during periods of inclement weather.

To utilize secure activity area 420, children 220 and adults 230 preferably enter same via step 590. Subsequently, adults 230 preferably provide labeled game equipment 200 to children 220 for use on activity areas 40 and children 220 preferably play therein via step 680. Concurrently, via step 690, adults 230 preferably observe children 220. Adults 230 further optionally cook (step 640), communicate (step 650), and/or socialize (step 660), and/or families comprising children 220 and adults 230 eat, communicate and or socialize (step 670).

It will be recognized by those skilled in the art that activity enclosure 420 could be rectangular in shape with triangular segments surrounding central observation area 30 and activity areas 40 could comprise other games, such as, for exemplary purposes only, golf pool.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method of marketing real estate, said method comprising the steps of:
providing an activity enclosure for common use having game activities therein, said activity enclosure comprising a central area adapted for observing children; and
offering a home for sale to purchasing occupants, wherein said purchasing occupants have access to, and use of, said activity enclosure.

2. The method of claim 1, further comprising the step of purchasing land.

3. The method of claim 2, further comprising the step of subdividing said land.

4. The method of claim 3, wherein said step of subdividing comprises the step of subdividing said land into home building lots and said commonly-usable activity enclosure.

5. The method of claim 4, further comprising the step of constructing homes on said home building lots.

6. The method of claim 5, further comprising the step of providing game equipment to said purchasing occupants, wherein said game equipment is adapted for use with said game activities.

7. The method of claim 6, further comprising the step of identifying said game equipment via indicia thereon, wherein said indicia identify said purchasing occupants.

8. The method of claim 1, further comprising the step of providing activity equipment suitable for use with said game activities, wherein said activity equipment is labeled with the name of at least one of said purchasing occupants.

9. The method of claim 1, further comprising the step of optionally performing an activity in said central area, said activity selected from the group consisting of cooking food, eating food, communicating with other purchasing occupants, socializing with other purchasing occupants, and combinations thereof.

10. The method of claim 1, further comprising the step of observing children while at play in said activity enclosure.

11. The method of claim 1, further comprising the step of socializing with other purchasing occupants while observing said children from said central area.

12. The method of claim 1, further comprising the step of cooking food while observing said children from said central area.

13. The method of claim 1, further comprising the step of constructing said game activities within said activity enclosure, wherein said game activities extend radially from said central area.

14. A method of marketing homes to prospective buyers, said method comprising the steps of: subdividing land into home lots and a secure activity enclosure;
constructing homes on said home lots;
offering said homes for sale, wherein said offering said homes for sale comprises access to said secure activity enclosure;
selling said homes;
permitting children to play in said secure activity enclosure; and
observing said children while at play from a central location within said secure activity enclosure.

15. The method of claim 14, further comprising the step of providing said children with game equipment, wherein said game equipment is labeled to identify a purchaser of one of said homes.

16. The method of claim 14, further comprising the step of constructing said secure activity enclosure on a piece of land that is otherwise unsuitable for constructing said homes.

17. The method of claim 14, further comprising the step of constructing play areas within said secure activity enclosure, wherein said play areas extend radially from said central location.

18. A method of marketing real estate, said method comprising the steps of:
constructing an activity enclosure in a housing subdivision, said activity enclosure comprising a central observation position and a plurality of activity areas radially-extending from said central observation position; and
offering homes in said subdivision for sale to prospective home purchasers.

19. The method of claim 18, further comprising the step of conveying marketing information pertaining to homes, wherein ownership of said homes comprises access to said activity enclosure, said marketing information indicating that said homes with access to said activity enclosure are available for sale.

20. The method of claim 19, wherein said step of conveying marketing information comprises the step of conveying marketing information via the Internet.
